(19) United States
(12) Patent Application Publication
(10) Pub. No.: US 2023/0006259 A1
(43) Pub. Date: Jan. 5, 2023

(54) FLAT NON-AQUEOUS ELECTROLYTE SECONDARY BATTERY

(71) Applicant: Panasonic Intellectual Property Management Co., Ltd., Osaka-shi, Osaka (JP)

(72) Inventors: Jun Kumagai, Osaka (JP); Toshie Wata, Hyogo (JP)

(73) Assignee: Panasonic Intellectual Property Management Co., Ltd., Osaka-shi, Osaka (JP)

(21) Appl. No.: 17/779,848

(22) PCT Filed: Dec. 8, 2020
(86) PCT No.: PCT/JP2020/045581

§ 371 Date: May 25, 2022

(30) Foreign Application Priority Data
Dec. 27, 2019 (JP) 2019-237591

(51) Int. Cl. H01M 10/0583

(52) U.S. Cl. CPC H01M 10/0583

(57) ABSTRACT

Positive and negative electrode plates of a battery include positive electrode units aligned and connected to one another and negative electrode units aligned and connected to one another, respectively. The electrode plates are folded, in a zigzag pattern, alternately in opposite directions at fold portions each being a boundary between corresponding adjacent two positive electrode units and at fold portions each being a boundary between corresponding adjacent two negative electrode units. The electrode plates and a separator are arranged such that an active material layer on the positive electrode units faces an active material layer on the negative electrode units across the separator, and the fold portions face the fold portions across the separator. The length of each positive electrode unit is greater than the length of each negative electrode units in a direction in which the electrode units are aligned, respectively.

### TECHNICAL FIELD

The present disclosure relates to a flat non-aqueous electrolyte secondary battery.

Flat non-aqueous electrolyte secondary batteries have been conventionally used as power sources for various electronic devices. Examples of the flat non-aqueous electrolyte secondary batteries include a battery including a wound electrode group and a battery including an electrode group folded in a zigzag pattern. The wound electrode group is formed by sandwiching a separator between a positive electrode plate and a negative electrode plate and winding them. The battery including an electrode group folded in a zigzag pattern is disclosed in, for example, PTL 1.

PTL 1 discloses an example an electrode group formed by deviating the extension direction of the positive electrode plate and the extension direction of the negative electrode plate by 90 degrees and folding the positive electrode plate and the negative electrode plate (see FIG. 2 of PTL 1). In the example, no active material layer is disposed on the fold portions of the electrode plates (see FIG. 1 of PTL 1).

### CITATION LIST

### Patent Literature

PTL 1: Japanese Patent Laid-Open Publication No. 2016-76329

### SUMMARY OF THE INVENTION

In the case that no active material layer is disposed on the fold portions of the electrode plates of the electrode group folded in a zigzag pattern, such portions do not contribute to the battery capacity. On the other hand, in the case that active material layers are disposed on the fold portions, lithium metal may be deposited on the fold portions due to repetitive charging and discharging. Such deposition of lithium metal may cause a short circuit of the battery and reduce battery capacity.

In view of the above, an object of the present disclosure is to provide a flat non-aqueous electrolyte secondary battery which includes an electrode group folded in a zigzag pattern and has a high battery capacity and a high reliability.

The inventors of the present application have found that the problems described above are solved by adopting a specific configuration. The present disclosure has been conceived based on such a new finding.

An aspect of the present disclosure relates to a flat non-aqueous electrolyte secondary battery. The flat non-aqueous electrolyte secondary battery includes a case having a flat shape, a positive electrode plate, a negative electrode plate, a separator, and a non-aqueous electrolyte. The positive electrode plate, the negative electrode plate, the separator, and the non-aqueous electrolyte are disposed in the case. The positive electrode plate includes three or more positive electrode units aligned and connected to one another. The negative electrode plate includes three or more negative electrode units aligned and connected to one another. Each of the three or more positive electrode units includes a positive electrode current collector and a positive electrode active material layer disposed on the positive electrode current collector. Each of the three or more negative electrode units includes a negative electrode current collector and a negative electrode active material layer disposed on the negative electrode current collector. The positive electrode plate is folded alternately in opposite directions at first fold portions in a zigzag pattern. Each of the first fold portions is a boundary between corresponding adjacent two of the three or more positive electrode units. The negative electrode plate is folded alternately in opposite directions at second fold portions in a zigzag pattern. Each of the second fold portions being a boundary between corresponding adjacent two of the three or more negative electrode units. The positive electrode active material layer is disposed on the first fold portions, and the negative electrode active material layer is disposed on the second fold portions. The positive electrode plate, the negative electrode plate, and the separator are arranged such that the positive electrode active material layer on the three or more positive electrode units faces the negative electrode active material layer on the three or more negative electrode units across the separator, and that the first fold portions face the second fold portions across the separator. A length X of each of the three or more positive electrode units in a direction in which the three or more positive electrode units are aligned is greater than a length Y of each of the three or more negative electrode units in a direction in which the three or more negative electrode units are aligned.

Another aspect of the present disclosure relates to another flat non-aqueous electrolyte secondary battery. The flat non-aqueous electrolyte secondary battery includes a case having a flat shape, a positive electrode plate, a negative electrode plate, a separator, and a non-aqueous electrolyte. The electrode plate, the negative electrode plate, the separator, and the non-aqueous electrolyte are disposed in the case. The positive electrode plate three or more positive electrode units aligned and connected to one another. The negative electrode plate includes three or more negative electrode units aligned and connected to one another. Each of the three or more positive electrode units includes a positive electrode current collector and a positive electrode active material layer disposed on the positive electrode current collector. Each of the three or more negative electrode units includes a negative electrode current collector and a negative electrode active material layer disposed on the negative electrode current collector. The positive electrode plate is folded in a zigzag pattern alternately in opposite directions at first fold portions, each of the first fold portions being a boundary between corresponding adjacent two of the three or more positive electrode units. The negative electrode plate is folded in a zigzag pattern alternately in opposite directions at second fold portions, each of the second fold portions being a boundary between corresponding adjacent two of the three or more negative electrode units. The positive electrode active material layer is disposed on the first fold portions, and the negative electrode active material layer is disposed on the second fold portions. The positive electrode plate, the negative electrode plate, and the separator are arranged such that the positive electrode active material layer on the three or more positive electrode units faces the negative electrode active material layer on the three or more negative electrode units across the separator, and that the first fold portions face the second fold portions across the separator. A distance L1 between the positive electrode active material layer at a center of each of the first fold portions and the negative electrode active material layer at a center of corresponding one of the second fold portions in a portion where the negative electrode plate covered with the positive electrode plate is greater than a distance L2 between the positive electrode active material layer at a center of each of the first fold portions and the negative electrode active material layer at a center of corresponding one of the second fold portions in a portion where the positive electrode plate is covered with the negative electrode plate.

According to the present disclosure, a flat non-aqueous electrolyte secondary battery includes an electrode group folded in a zigzag pattern, and has a high battery capacity and a high reliability.

### BRIEF DESCRIPTION OF THE DRAWINGS

FIG. 1 schematically illustrates an example of a cross section of a secondary battery according to an exemplary present embodiment.

FIG. 2 schematically illustrates an example of a cross section of an electrode group included in the secondary battery illustrated in FIG. 1.

FIG. 3A is a plane view of a positive electrode plate of the electrode group illustrated in FIG. 2 for illustrating a flat development thereof.

FIG. 3B is a cross-sectional view taken along line IIIB-IIIB of FIG. 3A.

FIG. 4A is a plane view of a negative electrode plate included in the electrode group illustrated in FIG. 2 for illustrating a flat development thereof.

FIG. 4B is a cross-sectional view taken along line IVB-IVB of FIG. 4A.

FIG. 5 schematically illustrates an arrangement of structural members of the electrode group illustrated in FIG. 2

FIG. 6 schematically illustrates a method of calculating a capacity loss rate.

### DESCRIPTION OF EMBODIMENT

Hereinafter, an embodiment of the present disclosure will be described. In the following description, although examples of the embodiment of the present disclosure will be described, the present disclosure is not limited to the examples. In the following description, although examples of specific numerical values and materials may be illustrated, other numerical values and materials may be applied as long as the advantageous effects of the present disclosure can be obtained.

Flat Non-Aqueous Electrolyte Secondary Battery

A first flat non-aqueous electrolyte secondary battery according to an exemplary embodiment of the present disclosure and a second flat non-aqueous electrolyte secondary battery according to another exemplary embodiment of the present disclosure will be described below. In the following description, the first flat non-aqueous electrolyte secondary battery may be referred to as a “first secondary battery”, and the second flat non-aqueous electrolyte secondary battery may be referred to as a “second secondary battery”. In one view point, the first secondary battery and the second secondary battery represent a battery of the present disclosure from different viewpoints. Accordingly, at least a portion of the battery included in the first secondary battery and at least a portion of the battery included in the second secondary battery overlap with each other.

Items Common to First Secondary Battery and Second Secondary Battery

Each of the first and second secondary batteries (flat non-aqueous electrolyte secondary batteries) includes a case having a flat shape, a positive electrode plate, a negative electrode plate, a separator, and a non-aqueous electrolyte. The positive electrode plate, the negative electrode plate, the separator and the non-aqueous electrolyte are disposed in the case. The positive electrode plate includes three or more positive electrode units aligned and connected to one another. The negative electrode plate includes three or more negative electrode units aligned and connected to one another. Each of the three or more positive electrode units includes a positive electrode current collector and a positive electrode active material layer disposed on the positive electrode current collector. Each of the three or more negative electrode units includes a negative electrode current collector and a negative electrode active material layer disposed on the negative electrode current collector. The positive electrode plate is folded in a zigzag pattern by folding the positive electrode plate alternately in opposite directions at first fold portions. Each of the first fold portions is a boundary between corresponding adjacent two of the positive electrode units. The negative electrode plate is folded in a zigzag pattern by folding the negative electrode plate alternately in opposite directions at second fold portions. Each of the second fold portions is a boundary between corresponding two of the negative electrode units. The positive electrode active material layer is disposed on the first fold portions and the negative electrode active material layer is disposed on the second fold portions. The positive electrode plate, the negative electrode plate, and the separator are arranged such that the positive electrode active material layer on the positive electrode units faces the negative electrode active material layer on the negative electrode units across the separator, and that the first fold portions face the second fold portions across the separator.

The folding of the electrode plate (positive electrode plate, negative electrode plate) in opposite directions means that the electrode plate is folded by approximately 180 degrees. By folding the electrode plate in opposite directions at the fold portions, the electrode plate is folded in a zigzag pattern.

In the first secondary battery, a length X of each positive electrode unit in the direction in which the positive electrode units are aligned is greater than length Y of each negative electrode unit in the direction in which the negative electrode units are aligned. Here, a length X of each positive electrode unit in the direction in which the positive electrode units are aligned refers to the length along the positive electrode plate. In other words, the length X is a length of each positive electrode unit in the direction in which the positive electrode units are aligned in a flat development of the positive electrode plate. Similarly, a length Y of each negative electrode unit in the direction in which the negative electrode units are aligned refers to the length of each negative electrode unit in the direction in which the negative electrode units are aligned in a flat development of the negative electrode plate.

In the first secondary battery, the three or more positive electrode units have the same planar shape (including substantially the same planar shape). In other words, lengths X of the positive electrode units are substantially equal to each other. Similarly, the three or more negative electrode units have the same planar shape (including substantially the same planar shape). In other words, lengths Y of the negative electrode units are substantially equal to each other. The three or more positive electrode units of the second secondary battery have the same planar shape, but may have different planar shapes. Similarly, the three or more negative electrode units of the second secondary battery have the same planar shape, but may have different planar shapes.

In the second secondary battery, distance L1 between the positive electrode active material layer at a center of the first fold portion and the negative electrode active material layer at a center of the second fold portion in each portion where the negative electrode plate is covered with the positive electrode plate is greater than distance L2 between the positive electrode active material layer at a center of the first fold portion and the negative electrode active material layer at a center of the second fold portion in each portion where the positive electrode plate is covered with the negative electrode plate.

In the following description, the portion where the negative electrode plate is covered with the positive electrode plate may be referred to as a “positive electrode active material excessive portion”. Similarly, in the following description, the portion where the positive electrode plate is covered with the negative electrode plate may be referred to as a “negative electrode active material excessive portion”.

Here, the center of the fold portion (first or second fold portion) in the positive electrode active material excessive portion or the negative electrode active material excessive portion refers to the outermost portion of the fold portion in the excessive portion in a cross section of the fold in directions in which the electrode plate units (positive electrode units or negative electrode units) are connected to one another in the zigzag pattern (that is, the cross section in FIG. 2 to be described later). For example, the center of the first fold portion in the positive electrode active material excessive portion is the outermost portion of the first fold portion in the cross section along directions in which the positive electrode units are connected to one another in the zigzag pattern (that is, the cross section in FIG. 2 to be described later). In a typical example, the boundary between adjacent two positive electrode units serves as the center of the first fold portion, and the boundary between adjacent two negative electrode units serves as the center of the second fold portion.

In the first and second secondary batteries, the active material layers are also disposed on both the first and second fold portions, accordingly increasing the capacity of the batteries.

In consideration of battery characteristics, a predetermined amount of active material is disposed on each of the positive electrode plate and the negative electrode plate per unit area of the positive electrode plate and the negative electrode plate. Accordingly, in the case that the positive electrode plate faces the negative electrode plate in parallel, the positive electrode active material faces the negative electrode active material at an ideal amount ratio as designed. However, in the electrode group folded in the zigzag pattern, the amount of the positive electrode active material is larger than the ideal amount ratio in the portion where the negative electrode plate is wrapped covered with the positive electrode plate. The inventors of the present application have found that when charging and discharging are repeated in the above case, the negative electrode active material layer cannot completely absorb the lithium ions released from the positive electrode active material layer, and lithium metal is likely to be deposited between the active material layers. Such a deposition of lithium metal may cause a short circuit of the battery and reduce a battery capacity. On the other hand, in the portion where the positive electrode plate is covered with the negative electrode plate, the amount of the negative electrode active material is larger than the ideal amount ratio. In such a case, even when charging and discharging are repeated, lithium metal is less likely to be deposited between the active material layers.

In the first and second secondary batteries, the gap between the positive electrode active material layer and the negative electrode active material layer in the positive electrode active material excessive portion may be greater than the gap between the positive electrode active material layer and the negative electrode active material layer in the negative electrode active material excessive portion. This configuration reduces the exchange of lithium ions in the positive electrode active material excessive portion, accordingly reducing the deposition of lithium metal in the portion.

In the first and second secondary batteries, the number N of positive electrode units included in each positive electrode plate is often equal to the number M of negative electrode units included in each negative electrode plate. In a preferred example, the number N of positive electrode units and the number M of negative electrode units are equal to each other and odd numbers, but may be even numbers.

The planar shape of each of the positive electrode units may be determined according to the shape of the case. The planar shape of the positive electrode unit may be a polygonal shape or a circular shape. In the case that the case has a quadrangular shape, a preferred example of the planar shape of the positive electrode unit has a rectangular shape, for example, a rectangular shape slightly smaller than one main surface of the case. In the case that the case has a coin shape, a preferred example of the planar shape of the positive electrode unit is a polygonal shape (for example, a hexagonal shape, an octagonal shape, or a decagonal shape) or a circular shape. The positive electrode unit may have a planar shape with a portion serving as the fold portion.

The planar shape of each of the negative electrode units may be determined similarly to the planar shape of each positive electrode unit as described above. In a preferred example, the planar shape of the positive electrode unit and the planar shape of the negative electrode unit are determined such that the area where the positive electrode active material faces the negative electrode active material is maximized. For example, the planar shape of the positive electrode unit may be substantially similar to the planar shape of the negative electrode unit. The planar shape of the positive electrode unit and the planar shape of the negative electrode unit are selected so as to satisfy the above described relation between length X and length Y and/or the above described relation between distance L1 and distance L2.

One positive electrode plate includes one positive electrode current collector and a positive electrode active material layer disposed on the current collector. The positive electrode active material layer disposed on the positive electrode current collector is continuous preferably without interruption. One negative electrode plate includes one negative electrode current collector and a negative electrode active material layer disposed on the current collector. The negative electrode active material layer disposed on the negative electrode current collector is continuous preferably without interruption.

In the first and second secondary batteries, the difference (X−Y) between length X and length Y may range from 0.1 mm to 0.3 mm. The difference (X− Y) in this range provides a highly reliable secondary battery with little loss of battery capacity.

If the thickness of the members (electrode plates, current collectors, separator) included in the electrode group is not taken into account, the difference (L1−L2) between distance L1 and distance L2 is regarded as being equal to the difference (X−Y). Hence, the difference (L1−L2) may range from 0.1 mm to 0.3 mm similarly to the difference (X−Y). With consideration for the thickness of the members included in the electrode group, the difference (L1−L2) may be slightly smaller than the preferred difference (X−Y). Length L2 is preferably small, and may be, for example, about the same as the thickness of the separator. In the case that the electrode group has different distances L1 and/or different distances L2, all of distances L1 and distances L2 may preferably satisfy the above relation.

The maximum length of the positive electrode unit in a direction perpendicular to the direction in which the positive electrode units are connected to one another is defined as width WX. The maximum length of the negative electrode units in a direction perpendicular to the direction in which the negative electrode units are connected to one another is defined as width WY. Width WX of the positive electrode units in the direction perpendicular to the direction in which the positive electrode units are connected to one another and width WY of the negative electrode units in the direction perpendicular to the direction in which the negative electrode units are connected to one another may satisfy the relation of WX>WY, but often satisfies the relation of WX≤WY. In addition, area SP of one positive electrode unit and area SN of one negative electrode unit may satisfy the relation of SP>SN, but often satisfies the relation of SP≤SN.

In the first and second secondary batteries, at least a portion of the separator may be fixed to the negative electrode plate (negative electrode active material layer) or may be fixed to the positive electrode plate (positive electrode active material layer). Such configurations facilitate the manufacture of batteries. The method of fixing the separator is not particularly limited, and a known technique may be used. For example, the separator may be fixed to the negative electrode plate by a hot press or the like. Alternatively, a separator having an adhesive layer on the surface may be used. As the adhesive layer, for example, a layer containing resin, such as polyvinylidene fluoride, may be used.

The first and second secondary batteries may include one or more positive electrode plates and one or more negative electrode plates such that the total number of the positive and negative electrode plates is two or three. Three examples (first to third arrangement examples) regarding the number of the positive and negative electrode plates and the arrangement of the active material layers will be described below.

In a first arrangement example, the number of the one or more positive electrode plates is one and the number of the one or more negative electrode plates is one. In this case, a positive electrode active material layer is disposed only on one surface of the positive electrode current collector, and a negative electrode active material layer is disposed on only one surface of the negative electrode current collector. In a second arrangement example, the number of the one or more positive electrode plates is two and the number of the one or more negative electrode plates is one. In this case, a positive electrode active material layer is disposed on only one surface of the positive electrode current collector, and negative electrode active material layers are disposed on each of both surfaces of the negative electrode current collector. In the second arrangement example, the two positive electrode plates and the one negative electrode plate are arranged such that the two positive electrode plates sandwich the one negative electrode plate. In a third arrangement example, the number of the one or more negative electrode plates is two, and the number of the one or more positive electrode plates is one. In this case, positive electrode active material layers are disposed on each of both surfaces of the positive electrode current collector, and a negative electrode active material layer is disposed on only one surface of the negative electrode current collector. In the third arrangement example, the one positive electrode plate and the two negative electrode plates are disposed such that the two negative electrode plates sandwich the one positive electrode plate.

In the first and second secondary batteries, in each portion (negative electrode active material excessive portion) where the positive electrode plate is covered with the negative electrode plate, the positive electrode active material layer at the first fold portion and the negative electrode active material layer at the second fold portion may contact the separator. This configuration also prevents lithium metal from being deposited in the negative electrode active material excessive portion.

In the first and second secondary batteries, a member which prevents the permeation of the non-aqueous electrolyte may be present or absent between the first fold portions and the second fold portions (particularly in the positive electrode active material excessive portion). A member which prevents the permeation of the non-aqueous electrolyte (in another viewpoint, a member which prevents the movement of lithium ions or a member which prevents the movement of the non-aqueous electrolyte solution) provided between the first fold portions and the second fold portions reduces the deposition of lithium metal in the portion. However, since the first and second secondary batteries each have a configuration which reduces the deposition of lithium metal in the positive electrode active material excessive portion, necessity for such a member is low. Elimination of the need for such a member facilitates the manufacturing and reduces the manufacturing cost. In addition, it is possible to prevent space loss caused due to the use of such a member.

Except for including the configuration specific to the present embodiment, the structural elements of the first and second secondary batteries (the case, the material of the positive electrode plate, the material of the negative electrode plate, the separator, the non-aqueous electrolyte, and other structural elements, etc.) are not particularly limited. For example, the first and second secondary batteries may include an insulator that insulates the periphery of the electrode group and other members. Except for including the configuration specific to the present embodiment, known materials and known configurations may be applied to the structural elements of the first and second secondary batteries. Although examples of such structural elements will be illustrated below, the present embodiment is not limited to the examples.

Positive Electrode Plate

The positive electrode plate includes a positive electrode current collector and a positive electrode active material layer. A portion of the positive electrode current collector may constitute a connection portion that is electrically connected to a portion of the case (a case body or a sealing plate) that functions as a terminal. In this case, the connection portion is connected to a portion of the case by, for example, welding, such as ultrasonic welding.

Examples of the positive electrode current collector include a sheet-like material, such as a foil, a mesh, or a punching sheet, made of conductive material, such as a metal material. Examples of the metal material included in the positive electrode current collector include aluminum, aluminum alloy, titanium, titanium alloy, and stainless steel. The thickness of the positive electrode current collector may range from, for example, 5 μm to 300 μm.

The positive electrode active material layer contains positive electrode active material, and may further contain other substances, such as binder and conductive agent, as necessary. Examples of the positive electrode active material include substance that reversibly releases lithium ions, that is, substance that releases and absorbs lithium ions. Specifically, examples of the positive electrode active material include metal oxide containing lithium, lithium-transition metal phosphate compound, and lithium-transition metal sulfate compound. Examples of the metal oxide containing lithium include lithium transition metal composite oxide, and lithium-nickel-cobalt-aluminum composite oxide. Examples of the lithium transition metal composite oxide include lithium-manganese composite oxide (e.g., LiMn₂O₄), lithium-nickel composite oxide (e.g., LiNiO₂), lithium-cobalt composite oxide (e.g., LiCoO₂), and composite oxide in which part of these transition metal elements are replaced with other metal elements (typical metal elements and/or transition metal elements).

Examples of the binder include fluorocarbon resin, polyacrylonitrile, polyimide resin, acrylic resin, polyolefin resin, and rubbery polymer. Examples of the fluorocarbon resin include polytetrafluoroethylene and polyvinylidene fluoride. Only one type of binder may be used, or two or more types of binders may be used.

Examples of the conductive agent include carbon material. Examples of the carbon material used as the conductive agent include carbon black (such as acetylene black or ketjen black), carbon nanotube, and graphite. Only one type of conductive agent may be used, or two or more types of conductive agents may be used.

Negative Electrode Plate

The negative electrode plate includes a negative electrode current collector and a negative electrode active material layer. A portion of the negative electrode current collector may constitute a connection portion electrically connected to a portion of the case (the case body or sealing plate) that functions as a terminal. In this case, the connection portion is connected to a portion of the case by, for example, welding, such as ultrasonic welding.

Examples of the negative electrode current collector include a sheet-like material (for example, a foil, a mesh, or a punching sheet) made of conductive material (for example, metal material). The metal material of the negative electrode current collector may be material that does not form lithium and neither alloy nor intermetallic compound. Examples of the metal material of the negative electrode current collector include copper, nickel, iron, and alloy containing these metal elements (such as copper alloy or stainless steel). In a preferred example, the metal material of the negative electrode current collector is copper or copper alloy. The thickness of the negative electrode current collector may range from, for example, 5 μm to 300 μm.

The negative electrode active material layer contains negative electrode active material, and may further contain other substances, such as binder, conductive agent, and thickener, as necessary. Examples of the negative electrode active material include substance that reversibly absorbs lithium ions, that is, substance that absorbs and releases lithium ions. Specifically, examples of the negative electrode active material include carbon material, silicon, silicon compound, and lithium alloy. Examples of the carbon material include graphite, coke, carbon undergoing graphitization, graphitized carbon fibers, and amorphous carbon.

Examples of the binder include fluorocarbon resin, such as polyvinylidene fluoride (PVDF), acrylic resin, such as polymethyl acrylate and ethylene-methyl methacrylic acid copolymer, styrene butadiene rubber, acrylic rubber, and modified products thereof. Examples of the conductive agent include the conductive agents indicated in the description of the positive electrode active material layer. Examples of the thickener include water-soluble polymer containing carboxyl groups (e.g., carboxymethyl cellulose).

Separator

Examples of the separator include an ion-permeable insulating sheet. The separator may include a stack of plural sheets including ion-permeable insulating sheets. The separator has a size larger enough to insulate the positive electrode plate from the negative electrode plate.

The separator may be a microporous film, a woven fabric, or a non-woven fabric. Examples of the material of the separator include insulating polymer, and specifically, polyolefin-based polymer, polyamide-based polymer, and cellulosic polymer. The thickness of the separator may range from 5 μm to 200 μm.

Non-Aqueous Electrolyte

The non-aqueous electrolyte may employ non-aqueous electrolyte having a lithium-ion conductivity. A typical non-aqueous electrolyte contains non-aqueous solvent, and lithium ions and anions which are dissolved in the non-aqueous solvent. The non-aqueous electrolyte may be in the form of liquid or gel. The liquid non-aqueous electrolyte can be prepared by dissolving lithium salt in non-aqueous solvent. Lithium ions and anions are produced by dissolving a lithium salt (salt of lithium ions and anions) in non-aqueous solvent.

The gel non-aqueous electrolyte contains liquid non-aqueous electrolyte and matrix polymer. As the matrix polymer, for example, a polymer material that absorbs a non-aqueous solvent and turns into a gel is used. Examples of such a polymer material include fluorocarbon resin, acrylic resin, and polyether resin.

Examples of the anions of the lithium salt includes BF₄⁻, ClO₄⁻, PF₆⁻, CF₃SO₃⁻, CF₃CO₂⁻, anions of imides, and anions of oxalate complexes.

Examples of the non-aqueous solvent include esters, ethers, nitriles, amides, and halogen substituents (e.g., fluorides) thereof. The non-aqueous electrolyte may contain only one type of these non-aqueous solvents, or may contain two or more types of these non-aqueous solvents.

Examples of the esters include carbonate ester, and carboxylic ester. Examples of cyclic carbonate ester include ethylene carbonate, propylene carbonate, and fluoroethylene carbonate (FEC). Examples of chain carbonate ester include dimethyl carbonate, ethyl methyl carbonate, and diethyl carbonate. Examples of cyclic carboxylic ester include γ-Butyrolactone, and γ-Valerolactone. Examples of chain carboxylic ester include ethyl acetate, methyl propionate, and methyl fluoropropionate.

The concentration of the lithium salt in the non-aqueous electrolyte may range, for example, from 0.5 mol/L to 3.5 mol/L. Here, the concentration of the lithium salt is the sum of the concentration of the dissociated lithium salt and the concentration of the undissociated lithium salt. The concentration of anions in the non-aqueous electrolyte may range from 0.5 mol/L to 3.5 mol/L.

Case

The flat case may has a rectangular (cuboid) shape or a coin shape (a columnar shape with a low profile). In other words, the first and second secondary batteries may be rectangular batteries or coin-shaped batteries. The coin-shaped case includes a case called a button-shaped case.

A typical case includes a case body, a sealing plate, and a gasket disposed between the case body and the sealing plate. The case body and the sealing plate often function as electrode terminals. For example, in the case of a general coin-shaped battery, the case body functions as a positive electrode terminal, and the sealing plate functions as a negative electrode terminal. The case body and the sealing plate may be made of metal, for example, conductive stainless steel.

The first and second secondary batteries and a method of manufacturing the first and second secondary batteries will be described below with reference to figures. The figures described below are schematic diagrams, and do not accurately reflect the actual configuration. As described above, since the basic configuration and manufacturing methods of the first and second secondary batteries are the same, they will be collectively described as the secondary battery according to Embodiment 1. Hereinafter, although an example of a coin-shaped battery will be described, the present disclosure is not limited to the example. The structural elements in the example described below may be modified based on the above description. In addition, items described below may be applied to the above described embodiment.

### Exemplary Embodiment 1

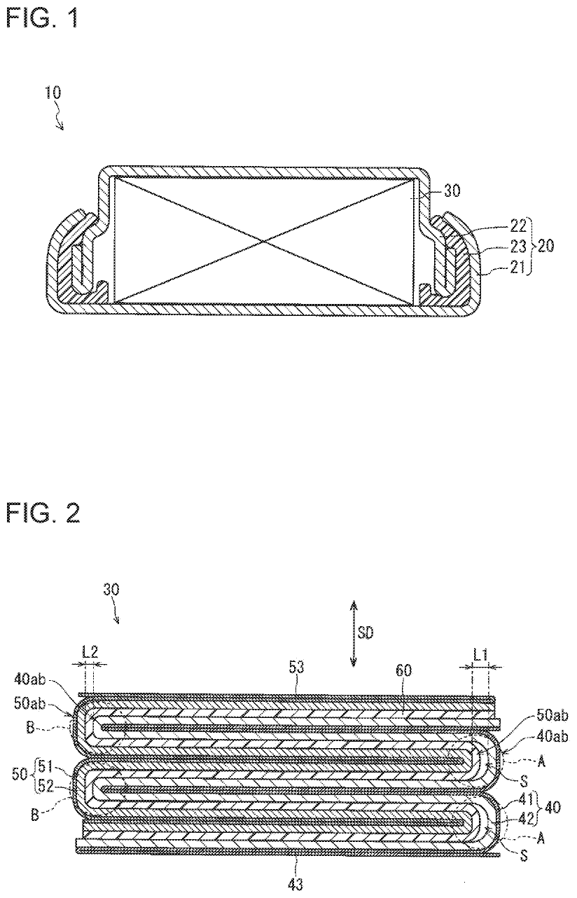

FIG. 1 schematically illustrates a cross section of a secondary battery according to exemplary Embodiment 1. Secondary battery 10 illustrated in FIG. 1 includes flat case 20 with a con shape, and electrode group 30 and a non-aqueous electrolyte (not illustrated) which are disposed in case 20. Case 20 includes case body 21 having a cylindrical shape with a closed end, sealing plate 22, and gasket 23. Case body 21 is sealed by sealing plate 22 and gasket 23.

FIG. 2 illustrates a cross section of electrode group 30. FIG. 2 illustrates a cross section taken along directions in which the positive electrode units and the negative electrode unit are connected to one another in a zigzag pattern. Electrode group 30 includes positive electrode plate 40, negative electrode plate 50, and one separator 60 disposed between positive electrode plate 40 and negative electrode plate 50. Each of positive electrode plate 40, negative electrode plate 50, and separator 60 is folded in a zigzag pattern.

Positive Electrode Plate

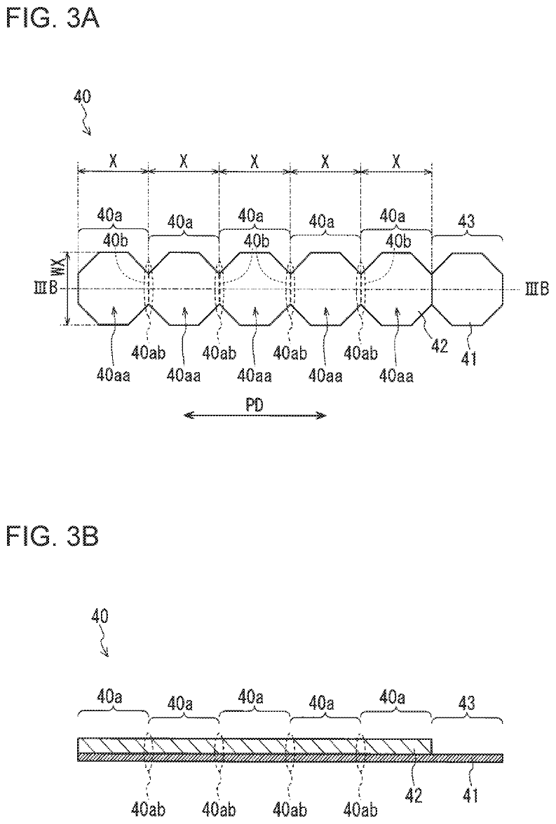

FIG. 3A illustrates a plane view of positive electrode plate 40 for illustrating a flat development thereof, and FIG. 3B illustrates a cross section of positive electrode plate 40 taken along line IIIB-IIIB shown in FIG. 3A. Positive electrode plate 40 includes positive electrode current collector 41 and positive electrode active material layer 42 disposed on positive electrode current collector 41. Positive electrode plate 40 includes five positive electrode units 40a aligned and connected to one another. Each positive electrode unit 40a includes positive electrode current collector 41 and positive electrode active material layer 42. Positive electrode units 40a have the same planar shape. Specifically, each positive electrode unit 40a in the example illustrated in FIG. 3A has an octagonal planar shape. In FIG. 3A, boundary 40b between adjacent two positive electrode units 40a is indicated by a dotted line. As illustrated in FIG. 3A, the length of each positive electrode unit 40a in direction PD (longitudinal direction) in which positive electrode units 40a aligned and connected to one another is defined as length X. The maximum length of each positive electrode unit 40a in a direction perpendicular to direction PD is defined as width WX. Lengths X of five positive electrode units 40a are equal to each other, and widths WX of five positive electrode units 40a are equal to each other.

Positive electrode plate 40 further includes connection portion 43 so as to electrically connect positive electrode plate 40 to case body 21. Connection portion 43 is connected to one end of positive electrode units 40a aligned and connected to one another. In the illustrated example, connection portion 43 is connected in the direction in which positive electrode units 40a are aligned and connected to one another.

In the illustrated example, connection portion 43 has substantially the same shape as positive electrode current collector 41 of each positive electrode unit 40a. Connection portion 43 is a portion connected to case body 21, and is connected to case body 21 by, for example, welding. As illustrated in the figure, a portion of a sheet of positive electrode current collector 41 serves as connection portion 43, and another portion of positive electrode current collector 41 serves as the current collector of positive electrode units 40a. Connection portion 43 is a portion of positive electrode current collector 41 onto which a positive electrode mixture is not applied. The structure of connection portion 43 is not particularly limited as long as positive electrode current collector 41 may be electrically connected to case body 21.

Positive electrode plate 40 is folded in a zigzag pattern as illustrated in FIG. 2 by folding positive electrode plate 40 alternately in opposite directions at first fold portions 40ab. Each of first fold portions 40ab is boundary between corresponding adjacent two positive electrode units 40a. In one aspect, each positive electrode unit 40a includes first fold portion 40ab and first stacking portion 40aa. First stacking portion 40aa is a portion to be stacked along stacking direction SD (see FIG. 2) of electrode group 30.

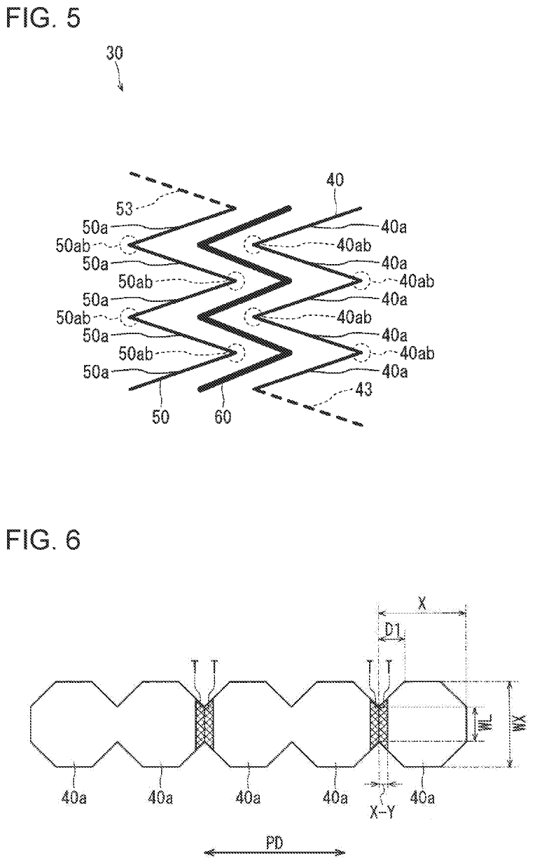

As illustrated in FIG. 2 and FIG. 5 to be described later, the boundary between connection portion 43 and positive electrode unit 40a is also folded as a fold portion.

Positive electrode active material layer 42 is disposed on the surface of positive electrode plate 40 facing negative electrode plate 50, except for connection portion 43. In other words, positive electrode active material layer 42 is disposed on both first stacking portions 40aa and first fold portions 40ab.

Negative Electrode Plate

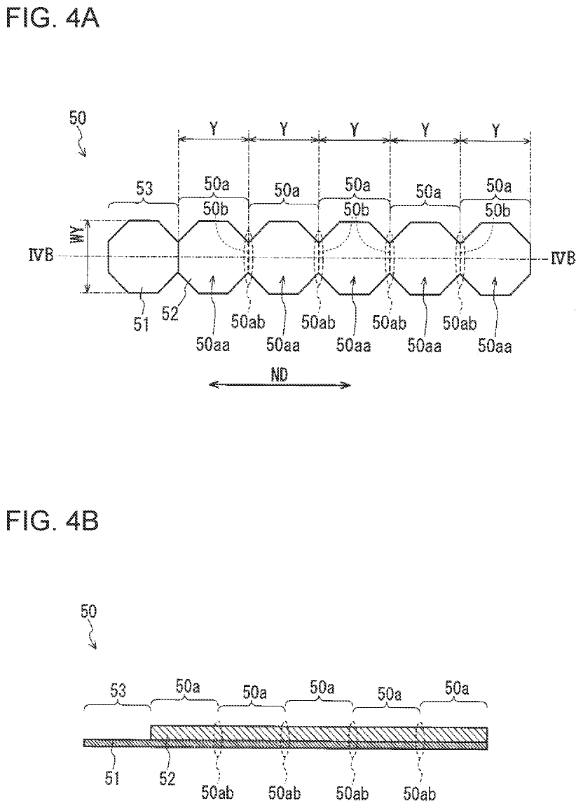

FIG. 4A illustrates a plan view of negative electrode plate 50 for illustrating a flat development thereof, and FIG. 4B illustrates a cross section of the plate taken along line IVB-IVB shown in FIG. 4A. Negative electrode plate 50 includes negative electrode current collector 51 and negative electrode active material layer 52 disposed on negative electrode current collector 51. Negative electrode plate 50 includes five negative electrode units 50a aligned and connected to one another. Each of negative electrode units 50a includes negative electrode current collector 51 and negative electrode active material layer 52. Negative electrode units 50a have the same planar shape. Specifically, each negative electrode unit 50a in the example illustrated in FIG. 4A has an octagonal planar shape. In FIG. 4A, boundary 50b between adjacent two negative electrode units 50a is indicated by a dotted line. As illustrated in FIG. 4A, the length of each negative electrode unit 50a in direction ND (longitudinal direction) in which negative electrode units 50a are aligned and connected to one another is defined as length Y. The maximum length of each negative electrode unit 50a in the direction perpendicular to direction ND is defined as width WY. Lengths Y of five negative electrode units 50a are equal to one another other, and width WY of five negative electrode units 50a are equal to one another.

Negative electrode plate 50 further includes connection portion 53 configured to electrically connecting negative electrode plate 50 to case body 21. Connection portion 53 is connected to one end of negative electrode units 50a aligned and connected to one another. In the illustrated example, connection portion 53 is connected in the direction in which negative electrode units 50a are aligned and connected to one another.

In the illustrated example, connection portion 53 has substantially the same shape as negative electrode current collector 51 of each negative electrode unit 50a. Connection portion 53 is a portion that is electrically connected to sealing plate 22, and is connected to sealing plate 22 by, for example, welding. As illustrated in the figure, a portion of a sheet of negative electrode current collector 51 serves as connection portion 53, and another portion of negative electrode current collector 51 serves the current collector of negative electrode units 50a. Connection portion 53 is a portion of negative electrode current collector 51 onto which a negative electrode mixture is not applied. The structure of connection portion 53 is not particularly limited as long as negative electrode current collector 51 can be electrically connected to sealing plate 22.

Negative electrode plate 50 is folded in a zigzag pattern as illustrated in FIG. 2 by folding negative electrode plate 50 alternately in opposite directions at second fold portions 50ab. Each of second fold portions 50ab is the boundary between corresponding adjacent two negative electrode units 50a. In one aspect, each negative electrode unit 50a includes second fold portion 50ab and second stacking portion 50aa. Second stacking portion 50aa is a portion to be stacked along stacking direction SD (see FIG. 2) of electrode group 30.

As illustrated in FIG. 2 and FIG. 5 to be described later, the plate is folded at the boundary between connection portion 53 and negative electrode unit 50a as a fold portion.

Negative electrode active material layer 52 is disposed on one surface of negative electrode plate 50 except for connection portion 53. In other words, negative electrode active material layer 52 is disposed on both second stacking portions 50aa and second fold portions 50ab.

FIG. 5 schematically illustrates an arrangement of positive electrode plate 40, negative electrode plate 50, and separator 60. FIG. 5 schematically illustrates a state in which the fold portions of electrode group 30 illustrated in FIG. 2 are slightly widened to separate the members from each other. In FIG. 5, connection portions 43 and 53 are indicated by dotted lines.

As illustrated in FIG. 5, first fold portions 40ab of positive electrode plate 40 faces second fold portions 50ab of negative electrode plate 50 across separator 60. As illustrated in FIG. 2, positive electrode active material layer 42 faces negative electrode active material layer 52 across separator 60. Positive electrode plate 40, negative electrode plate 50, and separator 60 are arranged so as to have such configurations.

In electrode group 30 shown in FIG. 2, upon contacting case 20, when positive electrode current collector 41 and/or negative electrode current collector 51 contacts case 20, a short circuit occurs. An insulator (for example, an insulating tape) for preventing such a short circuit may be disposed around electrode group 30. For example, an insulator for preventing the current collectors from contacting case 20 may be disposed outside the fold portions of positive electrode current collector 41 and negative electrode current collector 51.

As illustrated in FIG. 2, positive electrode plate 40, negative electrode plate 50, and separator 60 are arranged such that positive electrode active material layer 42 on positive electrode units 40a faces negative electrode active material layer 52 on negative electrode units 50a across separator 60, and that first fold portions 40ab faces second fold portions 50ab across separator 60.

Length X of each positive electrode unit 40a is greater than length Y of each negative electrode unit 50a. The difference (X−Y) between length X and length Y may be within the range described above. Width WX of each positive electrode unit and width WY of each negative electrode unit often satisfy the relation of WX≤WY.

As illustrated in FIG. 2, in each portion (positive electrode active material excessive portion A) where negative electrode plate 50 is covered with positive electrode plate 40, the distance between positive electrode active material layer 42 at the center of first fold portion 40ab and negative electrode active material layer 52 at the center of second fold portion 50ab is defined as distance L1. In each portion (negative electrode active material excessive portion B) where positive electrode plate 40 covered with negative electrode plate 50, the distance between positive electrode active material layer 42 at the center of first fold portion 40ab and negative electrode active material layer 52 at the center of second fold portion 50ab is defined as distance L2. Distance L1 is greater than distance L2. This relation may be satisfied by, for example, causing length X to be greater than length Y.

In positive electrode active material excessive portion A, the center of first fold portion 40ab refers to the outermost portion of first fold portion 40ab in positive electrode active material excessive portion A in the cross section of FIG. 2. The center of second fold portion 50ab refers to the outermost portion of second fold portion 50ab in positive electrode active material excessive portion A in the cross section of FIG. 2. Similarly, in negative electrode active material excessive portion B, the center of first fold portion 40ab refers to the outermost portion of first fold portion 40ab in negative electrode active material excessive portion B in the cross section of FIG. 2. The center of second fold portion 50ab refers to the outermost portion of second fold portion 50ab in negative electrode active material excessive portion B in the cross section of FIG. 2. In positive electrode active material excessive portion A, the center of first fold portion 40ab faces the center of second fold portion 50ab across separator 60. In negative electrode active material excessive portion B, the center of first fold portion 40ab faces the center of second fold portion 50ab across separator 60.

In positive electrode active material excessive portion A, gap S is often formed between positive electrode active material layer 42 and separator 60 and/or between negative electrode active material layer 52 and separator 60. On the other hand, in negative electrode active material excessive portion B, positive electrode active material layer 42 and negative electrode active material layer 52 may contact separator 60 with no gap in between.

The secondary battery according to Embodiment 1, as described above, reduces deposition of lithium metal (for example, dendritic deposition of lithium metal) in positive electrode active material excessive portion A. As a result, a highly reliable battery can be obtained. In addition, the secondary battery according to Embodiment 1 includes active materials disposed also on the fold portions, and has a large capacity of the secondary battery increased.

In accordance with Embodiment 1, the example including only one positive electrode plate, one negative electrode plate, and one separator in the electrode group has been described. However, either the number of the positive electrode plates or the number of the negative electrode plates may be only one, and the number of the other may be two. In such a case, an active material layer is disposed on each of both surfaces of the only one electrode plate, and an active material layer is disposed on one surface of each of the other two electrode plates. In this case, two separators are used. In the case that the battery includes only one positive electrode plate and two negative electrode plates, the one positive electrode plate, the two negative electrode plates, and the two separators are arranged in the order of a negative electrode current collector, a negative electrode active material layer, a separator, a positive electrode active material layer, a positive electrode current collector, a positive electrode active material layer, a separator, a negative electrode active material layer, and a negative electrode current collector which are folded in a zigzag pattern. Similarly, in the case that the battery includes only one negative electrode plate and two positive electrode plates, the two positive electrode plates, the one negative electrode plate, and two separators are arranged in the order of a positive electrode current collector, a positive electrode active material layer, a separator, a negative electrode active material layer, a negative electrode current collector, a negative electrode active material layer, a separator, a positive electrode active material layer, and a positive electrode current collector which are folded in a zigzag pattern. In the case that active material layers are disposed on both surfaces of the positive electrode plate (or negative electrode plate), each positive electrode unit (or each negative electrode unit) includes a positive electrode current collector (or a negative electrode current collector) and positive electrode active material layers (or negative electrode active material layers) disposed on both surfaces of the positive electrode current collector (or the negative electrode current collector).

Method of Manufacturing Flat Non-Aqueous Electrolyte Secondary Battery

An example of a method of manufacturing the secondary battery according to the present embodiment will be described below. Hereinafter, an example of the method of manufacturing secondary battery 10 described in Embodiment 1 will be described. The first and second secondary batteries may be manufactured by the method described below. Known techniques may be applied to the manufacturing processes described below. The method of manufacturing the secondary battery according to the present embodiment is not limited to that described below.

First, positive electrode plate 40 and negative electrode plate 50 are prepared. In a preferred example of a method of producing positive electrode plate 40, first, the materials of positive electrode active material layer 42 are mixed to prepare a positive electrode mixture. Next, positive electrode active material layer 42 is formed by applying the positive electrode mixture onto a conductive sheet (for example, a metal foil) to be positive electrode current collector 41. In such a manner, positive electrode plate 40 is produced. Positive electrode plate 40 is produced so as to have the structure (planar shape) described above. After forming positive electrode active material layer 42 in a predetermined region of the conductive sheet with a large area, the conductive sheet and positive electrode active material layer 42 are punched together with a punching die, thereby producing positive electrode plate 40.

Unlike the battery described in PTL 1 in which no active material layer is disposed on the fold portions of the electrode plates, the battery according to the present embodiment includes the active material layers disposed also on the first and second fold portions 40ab and 50ab. In this case, it is not necessary to apply different active material layers between the fold portions and the other portions. Accordingly, the positive electrode plate according to the present embodiment is manufactured easily (the same applies to the negative electrode plate).

In a preferred example of the method of producing negative electrode plate 50, first, materials of negative electrode active material layer 52 are mixed, thereby preparing a negative electrode mixture. Next, negative electrode active material layer 52 is formed by applying the negative electrode mixture onto a conductive sheet (for example, a metal foil) to be negative electrode current collector 51, thereby producing negative electrode plate 50. Negative electrode plate 50 is produced so as to have the structure (planar shape) described above. After forming negative electrode active material layer 52 in a predetermined region of the conductive sheet with a large area, the conductive sheet and negative electrode active material layer 52 are punched together with a punching die, thereby producing negative electrode plate 50.

Next, positive electrode plate 40, negative electrode plate 50, and separator 60 are arranged such that positive electrode active material layer 42 faces negative electrode active material layer 52 across separator 60. Then, positive electrode plate 40, negative electrode plate 50, and separator 60 are folded together in a zigzag pattern to produce an electrode group. Positive electrode plate 40, negative electrode plate 50, and separator 60 may be separately folded first, and then, combined to produce electrode group 30. In the production of electrode group 30, at least a portion of the separator may be fixed to positive electrode plate 40 or negative electrode plate 50 before the electrode plates are folded. Fixation of the separator facilitates production of the electrode group. The separator may be fixed by the method described above.

Next, connection portion 43 is electrically connected to case body 21. Similarly, connection portion 53 is electrically connected to sealing plate 22. These electrical connections can be made, for example, by welding (such as ultrasonic welding). A periphery of electrode group 30 may be protected as necessary by an insulator before or after the connections of the connection portions.

Next, electrode group 30 and anon-aqueous electrolyte are disposed in case body 21. Next, case body 21 is sealed with sealing plate 22 and gasket 23, thereby producing secondary battery 10 according to Embodiment 1.

### EXAMPLES

The present disclosure will be detailed by way of examples.

### Example 1

In Example 1, batteries having the same configuration as secondary battery 10 illustrated in FIG. 1 were produced. Here, the number of positive electrode units was five, and the number of negative electrode units was five. The planar shapes of the positive electrode units and the negative electrode units were substantially regular octagonal shapes. Then, plural batteries were produced with different values of length X and length Y. Widths WX and WY in the direction perpendicular to the longitudinal direction of the electrode plates were 5.7 mm in both the positive electrode units and the negative electrode units.

The positive electrode mixture for the positive electrode active material layer was prepared by mixing lithium cobalt oxide (LiCoO₂) which is a positive electrode active material, acetylene black which is a conductive agent, and polyvinylidene fluoride which is a binder at a mass ratio of 9:0.1:0.1. An aluminum foil with a thickness of 13 μm was used as the positive electrode current collector.

The negative electrode mixture for the negative electrode active material layer was prepared by mixing graphite which is a negative electrode active material, carboxymethyl cellulose which is a thickener, and styrene-butadiene rubber which is a binder at a mass ratio of 9:0.1:0.1. A copper foil with a thickness of 6 μm was used as the negative electrode current collector.

A microporous film made of polyolefin with a thickness of 14 μm was used as the separator. The non-aqueous electrolyte was prepared by dissolving LiPF₆ in non-aqueous solvent. The non-aqueous solvent was prepared by mixing ethylene carbonate, propylene carbonate, and methyl ethyl carbonate at a volume ratio of 30:1:61.

An electrode group was prepared by the above described method using the above described positive electrode plate, negative electrode plate, and separator. The electrode group was produced such that the fold portions of the negative electrode active material excessive portion included substantially no gap between the positive electrode active material layer and the separator and between the negative electrode active material layer and the separator. Then, the electrode group, the non-aqueous electrolyte, and a case with a coin shape were used to produce a coin-shaped non-aqueous electrolyte secondary battery by the above described method. The obtained secondary battery had a diameter of 9.0 mm and a height of 2.0 mm.

In this example, five types of secondary batteries (samples 1 to 4 and comparative sample 1) were produced with different values of length X and length Y. Then, a charge and discharge cycle test was conducted at 20° C. on samples of the five types of secondary batteries. In the charge and discharge cycle test, the charge and discharge cycle was repeated 1000 cycles each including charging and discharging. In the charge and discharge cycle test, charging was performed under the conditions of 4.35 V and 6 mA, and discharging was performed under the conditions of 3.0 V and 6 mA. Then, the battery capacity of each sample was measured before (initial state), during, and after the charge and discharge cycle test.

The five types of secondary batteries were disassembled after performing the charge and discharge cycles for 500 cycles. Then, each battery was visually inspected in whether or not lithium metal was deposited between the electrode plates.

Table 1 shows the values of length X and length Y of the five types of secondary batteries produced and the evaluation results. The number of cycles n in Table 1 is the number of cycles in which the battery capacity reaches 80% of the initial battery capacity. Table 1 further shows the calculation result of capacity loss rate R (%) on the assumption that the difference between length X and length Y does not contribute to the battery capacity. The calculation result is based on the assumption to be described later. With an increase in this value, the capacity loss increases. Hence, the value of capacity loss rate R (%) is preferably smaller. When length X and length Y are equal to each other, capacity loss rate R is 0%.

TABLE 1

| | | | | | | Capacity |
|---|---|---|---|---|---|---|
| | Length | Length | (X-Y) | Li metal | The number | Loss Rate |
| | X (mm) | Y (mm) | (mm) | deposition | of cycles n | R (%) |
| Sample 1 | 5.8 | 5.7 | 0.1 | None | 1000< | 0.84 |
| Sample 2 | 5.9 | 5.7 | 0.2 | None | 1000< | 1.76 |
| Sample 3 | 6.0 | 5.7 | 0.3 | None | 1000< | 2.73 |
| Sample 4 | 6.0 | 5.6 | 0.4 | None | 1000< | 3.79 |
| Comparative | 5.7 | 5.7 | 0.0 | Deposited | 750 | 0 |
| Sample 1 | | | | | | |

Samples 1 to 4 in which length X is greater than length Y correspond to the above described first secondary battery. The relation of length X greater than length Y causes distance L1 to be greater than distance L2. Accordingly, samples 1 to 4 correspond to the above described second secondary battery.

As shown in Table 1, in samples 1 to 4 with length X greater than length Y, no deposition of lithium metal was observed after the charge and discharge cycle test. On the other hand, in comparative sample 1 with length X that is equal to length Y, deposition of lithium metal was observed in the positive electrode active material excessive portions after the charge and discharge cycle test. Comparative sample 1 is thus more likely to cause a short circuit or a decrease in capacity due to repeated charging and discharging compared with samples 1 to 4.

As shown in Table 1, the secondary batteries of samples 1 to 4 maintained a battery capacity higher than 80% of the initial capacity even after 1000 cycles. On the other hand, the battery capacity of the secondary battery of comparative sample 1 was 80% of the initial capacity after 750 cycles. This result indicates that the secondary batteries of samples 1 to 4 have little deterioration caused due to repeated charging and discharging.

On the other hand, as shown in Table 1, an increase in value of the difference (X−Y) between length X and length Y increases the capacity loss rate accordingly. Therefore, the difference (X−Y) is preferably less than or equal to a certain value. Considering the value of capacity loss rate R, the value of the difference (X−Y) is preferably less than or equal to 0.3, and may more preferably ranges from 0.1 to 0.3. The values of length X are different between comparative sample 1 and samples 1 to 4. Hence, the result that a capacity loss rate of comparative sample 1 is smaller than a capacity loss rate of samples 1 to 4 does not necessarily indicate that a battery capacity of comparative sample 1 greater than a battery capacity of samples 1 to 4. Even if not all of the active material layers at the fold portions in the positive electrode active material excessive portions do not contribute to the battery capacity, the active material layer at the fold portions in the negative electrode active material excessive portions contributes to an increase in battery capacity. Accordingly, the battery in accordance with the embodiment has a larger battery capacity than a conventional battery.

Capacity Loss Rate R

The method of calculating capacity loss rate R will be described with reference to FIG. 6. FIG. 6 illustrates five positive electrode units 40a as an example. In the case that length X is greater than length Y, in the portions to be the positive electrode active material excessive portions, the positive electrode active material does not face the negative electrode active material in the four trapezoidal portions T illustrated in FIG. 6. In the case that the number of positive electrode units 40a is an odd number N, the number of trapezoidal portions T is N-1.

FIG. 6 illustrates width WX, width WL, and length D1. Width WX is the length of each positive electrode unit 40a in the width direction (5.7 mm in this example). Width WL is the length in the width direction at the boundary between adjacent two positive electrode units 40a, that is, the length of one side of the (octagonal) positive electrode unit at that portion. Length D1 is the length of one side of the octagon (one side including the hypotenuse of trapezoidal portion T), and is the length in direction PD in which positive electrode units 40a are continuous.

The size of trapezoidal portion T is expressed by the following formulae.

Upper base: WL

### Height: (X−Y)

Lower base: WL+(WX−WL)×(X−Y)/D1

### Area ST: {(WL+(WX−WL)×(X−Y)/D1)+WL}×(X−Y)/2

Total area of all trapezoidal portions: ST×(N-1)

A regular octagonal positive electrode unit with both length X and width WX of 5.7 mm has assize described below.

### Area: 26.9 mm²

### D1: 1.670 mm

### WL: 2.361 mm

Assuming that the values of D1 and WL do not change even when X and Y change, trapezoidal portion T when WX is 5.7 mm has a size described below.

Upper base: 2.361 mm

### Height: (X−Y)

Lower base: 2.361+(5.7-2.361)×(X−Y)/1.670

### Area ST: {(2.361+(5.7-2.361)×(X−Y)/1.670)+2.361}×(X−Y)/2

Capacity loss rate R described above can be regarded as equal to the proportion of the total area of trapezoidal portions T to the total area of the positive electrode units. Hence, capacity loss rate R is expressed as the formula below, where SP in the formula is the area of one positive electrode unit. The values of capacity loss rate R in Table 1 were obtained as follows.

Capacity loss rate R (%)=100×ST×(N-1)/(N×SP)

### INDUSTRIAL APPLICABILITY

The present disclosure can be used for flat non-aqueous electrolyte secondary batteries.

### REFERENCE MARKS IN THE DRAWINGS

10 secondary battery (flat non-aqueous electrolyte secondary battery)
20 case
30 electrode group
40 positive electrode plate
40a positive electrode unit
40ab first fold portion
41 positive electrode current collector
42 positive electrode active material layer
50 negative electrode plate
50a negative electrode unit
50ab second fold portion
51 negative electrode current collector
52 negative electrode active material layer
60 separator
X, Y length
L1, L2 distance

1. A flat non-aqueous electrolyte secondary battery comprising:
a case having a flat shape;
one or more positive electrode plates disposed in the case;
one or more negative electrode plates disposed in the case;
a separator disposed in the case; and
a non-aqueous electrolyte disposed in the case, wherein
a positive electrode plate out of the one or more positive electrode plates includes three or more positive electrode units aligned and connected to one another;
a negative electrode plate of the one or more negative electrode plates includes three or more negative electrode units aligned and connected to one another;
each of the three or more positive electrode units includes a positive electrode current collector and a positive electrode active material layer disposed on the positive electrode current collector,
each of the three or more negative electrode units includes a negative electrode current collector and a negative electrode active material layer disposed on the negative electrode current collector,
the positive electrode plate is folded alternately in opposite directions at first fold portions in a zigzag pattern, each of the first fold portions being a boundary between corresponding adjacent two of the three or more positive electrode units,
the negative electrode plate is folded alternately in opposite directions at second fold portions in a zigzag pattern, each of the second fold portions being a boundary between corresponding adjacent two of the three or more negative electrode units,
the positive electrode active material layer is disposed on the first fold portions, and the negative electrode active material layer is disposed on the second fold portions,
the positive electrode plate, the negative electrode plate, and the separator are arranged such that the positive electrode active material layer on the three or more positive electrode units faces the negative electrode active material layer on the three or more negative electrode units across the separator, and that the first fold portions face the second fold portions across the separator, and
a length X of each of the three or more positive electrode units in a direction in which the three or more positive electrode units are aligned is greater than a length Y of each of the three or more negative electrode units in a direction in which the three or more negative electrode units are aligned.

2. The flat non-aqueous electrolyte secondary battery according to claim 1, wherein a difference (X−Y) between the length X and the length Y ranges from 0.1 mm to 0.3 mm.

3. The flat non-aqueous electrolyte secondary battery according to claim 1, wherein a width WX of each of the three or more positive electrode units in a direction perpendicular to the direction in which the three or more positive electrode units are aligned and a width WY of each of the three or more negative electrode units in a direction perpendicular to the direction in which the three or more negative electrode units are aligned satisfy a relation of WX≤WY.

4. The flat non-aqueous electrolyte secondary battery according to claim 1, wherein at least a portion of the separator is fixed to the negative electrode plate.

5. The flat non-aqueous electrolyte secondary battery according to claim 1, wherein
in a case where a number of the one or more positive electrode plates is one and a number of one or more negative electrode plates is one, the positive electrode active material layer is disposed on only one surface of the positive electrode current collector, and the negative electrode active material layer is disposed on only one surface of the negative electrode current collector,
in a case where the number of the one or more positive electrode plates is two, the positive electrode active material layer is disposed on only one surface of the positive electrode current collector, and the negative electrode active material layer is disposed on each of both surfaces of the negative electrode current collector, and
in a case where the number of the one or more negative electrode plates is two, the positive electrode active material layer is disposed on each of both surfaces of the positive electrode current collector and the negative electrode active material layer is disposed on only one surface of the negative electrode current collector.

6. The flat non-aqueous electrolyte secondary battery according to claim 1, wherein the positive electrode active material layer on the first fold portions and the negative electrode active material layer on the second fold portions contact the separator at a portion of the positive electrode plate covered with the negative electrode plate.

7. The flat non-aqueous electrolyte secondary battery according to claim 1, wherein no member which prevents permeation of the non-aqueous electrolyte is provided between each of the first fold portions and corresponding one of the second fold portions.

8. A flat non-aqueous electrolyte secondary battery comprising:
a one or more case having a flat shape;
one or more positive electrode plates disposed in the case;
one or more negative electrode plates disposed in the case;
a separator disposed in the case; and
a non-aqueous electrolyte disposed in the case, wherein
a positive electrode plate out of the one or more positive electrode plates includes three or more positive electrode units aligned and connected to one another;
a negative electrode plate out of the one or more negative electrode plates includes three or more negative electrode units aligned and connected to one another;
each of the three or more positive electrode units includes a positive electrode current collector and a positive electrode active material layer disposed on the positive electrode current collector,
each of the three or more negative electrode units includes a negative electrode current collector and a negative electrode active material layer disposed on the negative electrode current collector,
the positive electrode plate is folded alternately in opposite directions at first fold portions in a zigzag pattern, each of the first fold portions being a boundary between corresponding adjacent two of the three or more positive electrode units,
the negative electrode plate is folded alternately in opposite directions at second fold portions in a zigzag pattern, each of the second fold portions being a boundary between corresponding adjacent two of the three or more negative electrode units,
the positive electrode active material layer is disposed on the first fold portions, and the negative electrode active material layer is disposed on the second fold portions,
the positive electrode plate, the negative electrode plate, and the separator are arranged such that the positive electrode active material layer on the three or more positive electrode units faces the negative electrode active material layer on the three or more negative electrode units across the separator, and that the first fold portions face the second fold portions across the separator, and
a distance L1 between the positive electrode active material layer at a center of each of the first fold portions and the negative electrode active material layer at a center of corresponding one of the second fold portions in a portion where the negative electrode plate covered with the positive electrode plate is greater than a distance L2 between the positive electrode active material layer at a center of each of the first fold portions and the negative electrode active material layer at a center of corresponding one of the second fold portions in a portion where the positive electrode plate is covered with the negative electrode plate.

9. The flat non-aqueous electrolyte secondary battery according to claim 8, wherein a difference (X−Y) between a length X of each of the three or more positive electrode units in a direction in which the three or more positive electrode units align and a length Y of each of the three or more negative electrode units in a direction in which the three or more negative electrode units align ranges from 0.1 mm to 0.3 mm.

10. The flat non-aqueous electrolyte secondary battery according to claim 8, wherein a width WX of each of the three or more positive electrode units in a direction perpendicular to the direction in which the three or more positive electrode units are aligned and a width WY of each of the three or more negative electrode units in a direction perpendicular to the direction in which the three or more negative electrode units are aligned satisfy a relation of WX≤WY.

11. The flat non-aqueous electrolyte secondary battery according to claim 8, wherein at least a portion of the separator is fixed to the negative electrode plate.

12. The flat non-aqueous electrolyte secondary battery according to claim 8, wherein
in a case where a number of the one or more positive electrode plates is one and a number of the one or more negative electrode plates is one, the positive electrode active material layer is disposed on only one surface of the positive electrode current collector, and the negative electrode active material layer is disposed on only one surface of the negative electrode current collector,
in a case where the number of the one or more positive electrode plates is two, the positive electrode active material layer is disposed on only one surface of the positive electrode current collector, and the negative electrode active material layer is disposed on each of both surfaces of the negative electrode current collector, and
in a case where the number of the one or more negative electrode plates is two, the positive electrode active material layer is disposed on each of both surfaces of the positive electrode current collector, and the negative electrode active material layer is disposed on only one surface of the negative electrode current collector.

13. The flat non-aqueous electrolyte secondary battery according to claim 8, wherein, in a portion where the positive electrode plate is covered with the negative electrode plate, the positive electrode active material layer on the first fold portions and the negative electrode active material layer on the second fold portions contact the separator.

14. The flat non-aqueous electrolyte secondary battery according to claim 8, wherein no member which prevents permeation of the non-aqueous electrolyte is provided between each of the first fold portions and each of the second fold portions.
